(19) United States
(12) Patent Application Publication
(10) Pub. No.: US 2019/0210150 A1
(43) Pub. Date: Jul. 11, 2019

(54) CUTTING ASSEMBLY AND METHOD FOR MANUFACTURING SAME

(71) Applicants: HANGZHOU GREAT STAR INDUSTRIAL CO., LTD., Hangzhou City, Zhejiang Province (CN); HANGZHOU GREAT STAR TOOLS CO., LTD., Hangzhou City, Zhejiang Province (CN)

(72) Inventor: Weiyi Wang, Hangzhou City, Zhejiang Province (CN)

(21) Appl. No.: 15/764,991

(22) PCT Filed: Jan. 11, 2018
(86) PCT No.: PCT/CN2018/072230

§ 371 Date: Mar. 30, 2018

(51) Int. Cl. B23K 26/32; B23K 26/60; B23D 61/12; C21D 6/00

(52) U.S. Cl. CPC B23K 26/32; B23K 26/60; B23D 61/125; B23K 2103/04; C21D 6/005; C21D 6/008; C21D 6/004

(57) ABSTRACT

The present invention discloses a cutting assembly. The cutting assembly includes a substrate, a cutting edge, and a welding portion. The substrate includes a first metal portion, and the first metal portion has a first side surface. The cutting edge is formed by overlapping a second metal portion with a third metal portion used for an edge, the second metal portion is of high-strength alloy steel and has a second side surface, and the third metal portion is of high-speed tool steel and has a third side surface. The welding portion connects the first metal portion and the second metal portion. The present invention further provides a method for manufacturing a cutting assembly, including: welding a composite steel strip to a substrate, to form a blank body of the cutting assembly; and then performing low-temperature tempering treatment on a welding portion. The cutting assembly in the present invention uses three metal structures, and uses medium-high carbon steel or low alloy steel with relatively low costs as a material of the substrate, so that the costs of a hand saw with a relatively size to which the cutting assembly is applied can be reduced. A tooth tip of the hand saw uses a high-speed steel material such as M2, M42, or M35, so that the abrasive resistance of the hand saw is dramatically improved, and the service life of the saw is increased.

### FIELD OF THE INVENTION

The present invention relates to cutting assemblies, and in particular, to a cutting assembly formed by welding a metal material, and a method for manufacturing same.

### DESCRIPTION OF THE PRIOR ART

Tooth tips of common bladed saws are usually made of materials such as entire medium-high carbon steel or entire low alloy steel, for example, 65Mn, SK5, or 50#. However, due to a limitation of materials, a tooth tip of a bladed saw using the material as a whole has poor abrasive resistance.

If a super-wide bimetal composite steel strip is used for an entire hand saw, the hand saw has a width of at least 90 mm. Because a backing material of a bimetal composite steel strip saw blade is generally high-strength alloy steel, and a total content of alloy elements exceeds 5.0%, excessively high costs are caused and the hand saw is less competitive in the market.

In addition, if the super-wide bimetal composite steel strip is used, after a wire of high-speed steel such as M2 or M42 is butt welded to the high-strength alloy steel such as D6A or X32 used as the backing material, overall heat treatment of a high-speed steel technique needs to be performed in a subsequent heat treatment process, and high-temperature tempering needs to be performed, causing a substrate of the saw blade to have low hardness, which is of only approximately 30 HRC, and have poor strength. In addition, the saw blade greatly deforms and is difficult to control.

### SUMMARY OF THE INVENTION

In view of the foregoing disadvantages in the prior art, a technical problem to be resolved in the present invention is to provide a cutting assembly having abrasive resistance, toughness, and high hardness.

The present invention provides a cutting assembly.

The cutting assembly includes a substrate, a cutting edge, and a welding portion.

The substrate includes a first metal portion, and the first metal portion is of medium-high carbon steel or low alloy steel and has a first side surface.

The cutting edge is formed by overlapping a second metal portion with a third metal portion used for an edge, the second metal portion is of high-strength alloy steel and has a second side surface, and the third metal portion is of high-speed tool steel and has a third side surface.

The welding portion connects the first metal portion and the second metal portion.

Further, the cutting edge is a composite steel strip that is formed by overlapping the second metal portion and the third metal portion used for the edge.

Further, the high-speed tool steel has hardness of 58 HRC to 72 HRC.

Further, the high-strength alloy steel has hardness of 38 HRC to 52 HRC.

Further, the medium-high carbon steel or the low alloy steel has hardness of 38 HRC to 52 HRC.

Further, a carbon content of the second metal portion is 0.30% to 0.60%, and a total content of alloy elements is 2.0% to 8.0%.

Further, the alloy elements include any one or more of Cr, V, Mo, Ni, W, Ti, Si, and Mn.

Further, the high-strength alloy steel includes any one or more of D6A, X32, and 50CrV.

Further, the third metal portion is of high-speed tool steel whose carbon content is not less than 0.70%.

Further, the high-speed tool steel includes M2, M42, or M35.

Further, the medium-high carbon steel or the low alloy steel has hardness of 38 HRC to 52 HRC.

Further, the first metal portion includes 65Mn steel, SK5 steel, and 50# steel.

Further, the third metal portion has a width of 1.0 mm to 4.0 mm.

Further, the second metal portion has a width of 2.0 mm to 30.0 mm.

Further, the first metal portion has a width of 30.0 mm to 100.0 mm.

The present invention further provides a hand saw, including the cutting assembly described above.

The present invention further provides a method for manufacturing a cutting assembly. The manufacturing method includes: welding a composite steel strip formed by using a second metal portion and a third metal portion to a substrate, to form a blank body of the cutting assembly, where a welding process occurs between the second metal portion and a first metal portion as the substrate, and a welding portion is formed between the second metal portion and the first metal portion after the welding; and then performing low-temperature tempering treatment on the welding portion, to relieve welding stress of the welding portion.

Further, a tempering temperature of the low-temperature tempering treatment is 180° C. to 450° C., and a soaking time is 60 minutes to 240 minutes.

Further, after the low-temperature tempering treatment, the hardness of the third metal portion is reduced by at most 1.0 HRC, and the hardness of the first metal portion and the hardness of the second metal portion are reduced by at most 2.0 HRC.

Further, the composite steel strip formed by using the second metal portion and the third metal portion are welded to the substrate by means of high-energy beam welding, to form the blank body of the cutting assembly.

Further, the high-energy beam welding includes laser welding, electronic beam welding, or ion beam welding.

Further, a metallurgical structure of the second metal portion near the welding portion includes a cryptocrystalline martensite and some carbide structures.

Further, a metallurgical structure of the first metal portion near the welding portion includes a martensite, ferrite, and a carbide structure.

Further, neither of welding heat affected zones of the first metal portion and the second metal portion has a depth greater than 3.0 mm.

Further, a pulse laser whose wavelength is 1064 nm is used for the welding, and a welding torch moves at a speed of 5 mm/s to 50 mm's.

Further, when a continuous rare-earth doped laser whose wavelength is 1070 nm±10 nm is used for the welding, a laser welding joint moves at a speed of 5 mm/s to 50 mm/s.

The present invention has the following beneficial effects:

1. The cutting assembly in the present invention uses three metal structures, and uses medium-high carbon steel or low alloy steel with relatively low costs as a material of the substrate, so that the costs of a hand saw with a relatively size to which the cutting assembly is applied can be reduced. A tooth tip of the hand saw uses a high-speed steel material such as M2, M42, or M35, so that the abrasive resistance of the hand saw is dramatically improved, and the service life of the saw is increased.

2. The cutting assembly in the present invention may use a mature bimetal composite steel strip that is produced for commercial purposes. The bimetal composite steel strip is welded after heat treatment, ensuring the hardness of a saw blade and a tooth portion, achieving high abrasive resistance of a tooth tip, and ensuring high toughness of the saw blade.

3. A common saw blade is used as the substrate, and a narrow bimetal composite steel strip is used as a material of the tooth portion, so that the saw has a relatively high price-performance ratio.

### BRIEF DESCRIPTION OF THE DRAWINGS

FIG. 1 is a schematic diagram of a cutting assembly according to the present invention;

FIG. 2 is a partial sectional view of FIG. 1;

FIG. 3 is a schematic partially enlarged view of FIG. 2; and

FIG. 4 is a technical flowchart of a method for manufacturing a cutting assembly according to the present invention.

### REFERENCE NUMERALS

In the figures, 1: Substrate; 11: First metal portion; 2: Cutting edge; 21: Second metal portion; 22: Third metal portion 22.

### DETAILED DESCRIPTION OF THE PREFERRED EMBODIMENTS

The following further describes the present invention in detail with reference to the accompanying drawings and data. It should be understood that, the implementations are merely examples for describing the present invention, but are not intended to limit the scope of the present invention in any manner.

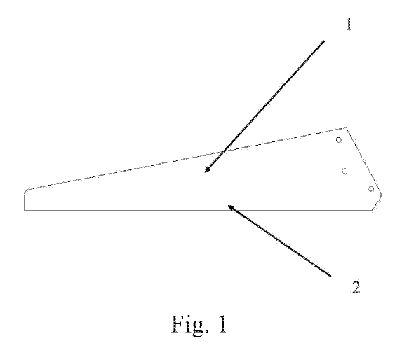

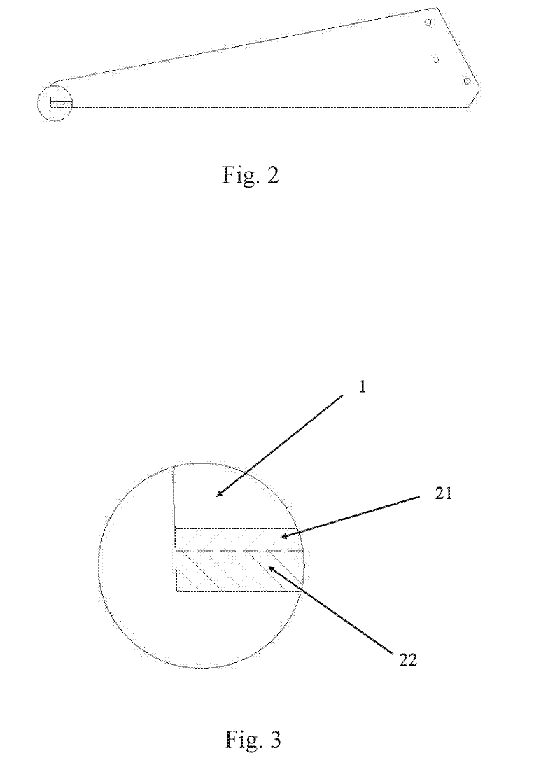

As shown in FIG. 1 to FIG. 3, the present invention provides a cutting assembly.

The cutting assembly includes a substrate, a cutting edge, and a welding portion. The cutting assembly uses three metal structures, that is, the cutting assembly is formed by using three metal materials with different performance.

The substrate includes a first metal portion, and the first metal portion is of medium-high carbon steel or low alloy steel and has a first side surface.

The cutting edge is formed by overlapping a second metal portion with a third metal portion used for an edge, the second metal portion is of high-strength alloy steel and has a second side surface, and the third metal portion is of high-speed tool steel and has a third side surface.

The welding portion connects the first metal portion and the second metal portion.

The medium-high carbon steel or the low alloy steel is selected as the substrate of the cutting assembly, and serves as a material of a large part of a backing material of the cutting assembly, thereby dramatically reducing the overall costs of the cutting assembly.

The high-strength alloy steel is selected as a transition part for welding. The welding occurs between the first metal portion and the second metal portion. After the welding, low-temperature tempering is directly performed, to relieve welding stress at a welding seam between the first metal portion and the second metal portion. Therefore, for the structure of this product, low-temperature treatment is implemented, that is, the welding stress between the first metal portion and the second metal portion can be relieved. In addition, a cutting assembly that has relatively low costs and has an edge with desired abrasive resistance performance is obtained.

The high-speed tool steel has hardness of 58 HRC to 72 HRC, and a carbon content of the high-speed tool steel is not less than 0.70%. In a preferred embodiment, the high-speed tool steel includes M2, M42, or M35.

The high-strength alloy steel has hardness of 38 HRC to 52 HRC. A carbon content of the second metal portion that is of the high-strength alloy steel is 0.30% to 0.60%, and a total content of alloy elements is 2.0% to 8.0%. The alloy elements include, but are not limited to: Cr, V, Mo, Ni, W, Ti. Si, and Mn. In a preferred embodiment, D6A, X32, or 50CrV may be selected for the high-strength alloy steel.

The medium-high carbon steel or the low alloy steel has hardness of 38 HRC to 52 HRC, and the first metal portion has hardness of 38 HRC to 52 HRC. In a preferred embodiment, the first metal portion includes 65Mn, SK5, and 50#. Preferably, the first metal portion has a width of 30.0 mm to 100.0 mm.

In an embodiment, the cutting edge has a relatively small width. Specifically, the third metal portion has a width of 1.0 mm to 4.0 mm, and the second metal portion has a width of 2.0 mm to 30.0 mm.

In an embodiment, the cutting edge is a composite steel strip that is formed by overlapping the second metal portion and the third metal portion used for the edge. A mature bimetal steel strip that is produced for commercial purposes may be selected for the composite steel strip.

In an embodiment, the present invention provides a hand saw, including the cutting assembly described above. Preferably, the first metal portion of the hand saw has a width of 30.0 mm to 100.0 mm.

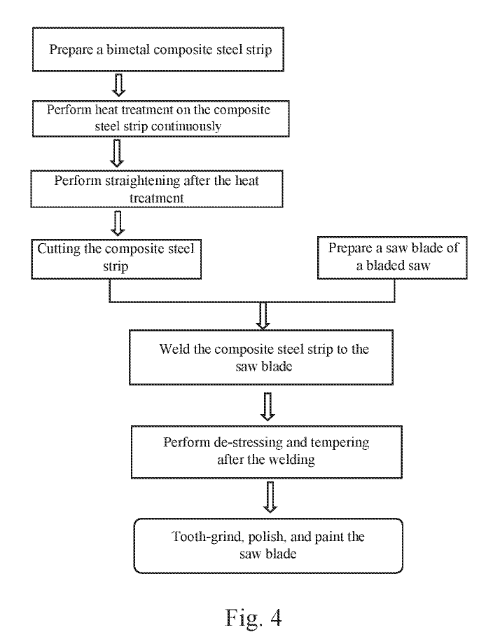

As shown in FIG. 4, the present invention further provides a method for manufacturing a cutting assembly. The manufacturing method includes: welding a composite steel strip formed by using a second metal portion and a third metal portion to a substrate, to form a blank body of the cutting assembly, where a welding process occurs between the second metal portion and a first metal portion as the substrate, and a welding portion is formed between the second metal portion and the first metal portion after the welding; and then performing low-temperature tempering treatment on the welding portion, to relieve welding stress of the welding portion.

A welding technique is specifically as follows:

The composite steel strip formed by using the second metal portion and the third metal portion are welded to the substrate by means of high-energy beam welding, to form the blank body of the cutting assembly. After the welding, a metallurgical structure of the second metal portion near the welding portion includes a cryptocrystalline martensite and some carbide structures. A metallurgical structure of the first metal portion near the welding portion includes a martensite, ferrite, and a carbide structure. Neither of welding heat affected zones of the first metal portion and the second metal portion has a depth greater than 3.0 mm. Preferably, a pulse laser whose wavelength is 1064 nm is used for the welding, and a welding torch moves at a speed of 5 mm/s to 50 mm/s. Alternatively, when a continuous rare-earth doped laser whose wavelength is 1070 nm±10 nm is used for the welding, a laser welding joint moves at a speed of 5 mm/s to 50 mm/s.

In an embodiment, a saw blade of a bladed saw is used as the substrate.

In an embodiment, the high-energy beam welding uses laser welding, electronic beam welding, or ion beam welding.

The low-temperature tempering treatment is specifically as follows:

A tempering temperature of the low-temperature tempering treatment is 180° C. to 450° C., and a soaking time is 60 minutes to 240 minutes.

After the low-temperature tempering treatment, the hardness of the third metal portion is reduced by at most 1.0 HRC, and the hardness of the first metal portion and the hardness of the second metal portion are reduced by at most 2.0 HRC.

The foregoing describes the specific exemplary embodiments of the present invention in detail. It should be understood that, a person of ordinary skill in the art may make various modifications or changes according to the concept of the present invention without creative efforts. Therefore, any technical solution that can be obtained by a person skilled in the art by way of logical analysis, reasoning, or limited experiments based on the prior art and according to the concept of the present invention shall fall within the protection scope of the claims of the present invention.

1. A cutting assembly, wherein
the cutting assembly comprises a substrate, a cutting edge, and a welding portion;
the substrate comprises a first metal portion, and the first metal portion is of medium-high carbon steel or low alloy steel and has a first side surface;
the cutting edge is formed by overlapping a second metal portion with a third metal portion used for an edge, the second metal portion is of high-strength alloy steel and has a second side surface, and the third metal portion is of high-speed tool steel and has a third side surface; and
the welding portion connects the first metal portion and the second metal portion.

2. The cutting assembly according to claim 1, wherein the cutting edge is a composite steel strip that is formed by overlapping the second metal portion and the third metal portion used for the edge.

3. The cutting assembly according to claim 1, wherein the high-speed tool steel has hardness of 58 HRC to 72 HRC.

4. The cutting assembly according to claim 1, wherein the high-strength alloy steel has hardness of 38 HRC to 52 HRC.

5. The cutting assembly according to claim 1, wherein the medium-high carbon steel or the low alloy steel has hardness of 38 HRC to 52 HRC.

6. The cutting assembly according to claim 1, wherein a carbon content of the second metal portion is 0.30% to 0.60%, and a total content of alloy elements is 2.0% to 8.0%.

7. The cutting assembly according to claim 6, wherein the alloy elements comprise any one or more of Cr, V, Mo, Ni, W, Ti, Si, and Mn.

8. The cutting assembly according to claim 1, wherein the high-strength alloy steel comprises any one or more of D6A, X32, and 50CrV; the high-speed tool steel comprises M2, M42, or M35; and the first metal portion comprises 65Mn steel, SK5 steel, and 50# steel.

9. The cutting assembly according to claim 1, wherein the third metal portion is of high-speed tool steel whose carbon content is not less than 0.70%.

10-12. (canceled)

13. The cutting assembly according to claim 1, wherein the third metal portion has a width of 1.0 mm to 4.0 mm; the second metal portion has a width of 2.0 mm to 30.0 mm; and the first metal portion has a width of 30.0 mm to 100.0 mm.

14-15. (canceled)

16. A hand saw, wherein the hand saw comprises the cutting assembly according to claim 1.

17. A method for manufacturing a cutting assembly, wherein the manufacturing method comprises:
welding a composite steel strip formed by using a second metal portion and a third metal portion to a substrate, to form a blank body of the cutting assembly, wherein a welding process occurs between the second metal portion and a first metal portion as the substrate, and a welding portion is formed between the second metal portion and the first metal portion after the welding; and
then performing low-temperature tempering treatment on the welding portion, to relieve welding stress of the welding portion.

18. The method for manufacturing a cutting assembly according to claim 17, wherein a tempering temperature of the low-temperature tempering treatment is 180° C. to 450° C., and a soaking time is 60 minutes to 240 minutes.

19. The method for manufacturing a cutting assembly according to claim 17, wherein after the low-temperature tempering treatment, the hardness of the third metal portion is reduced by at most 1.0 HRC, and the hardness of the first metal portion and the hardness of the second metal portion are reduced by at most 2.0 HRC.

20. The method for manufacturing a cutting assembly according to claim 17, wherein the composite steel strip formed by using the second metal portion and the third metal portion are welded to the substrate by means of high-energy beam welding, to form the blank body of the cutting assembly.

21. The method for manufacturing a cutting assembly according to claim 20, wherein the high-energy beam welding comprises laser welding, electronic beam welding, or ion beam welding.

22. The method for manufacturing a cutting assembly according to claim 17, wherein a metallurgical structure of the second metal portion near the welding portion comprises a cryptocrystalline martensite and some carbide structures; and a metallurgical structure of the first metal portion near the welding portion comprises a martensite, ferrite, and a carbide structure.

23. (canceled)

24. The method for manufacturing a cutting assembly according to claim 20, wherein neither of welding heat affected zones of the first metal portion and the second metal portion has a depth greater than 3.0 mm.

25. The method for manufacturing a cutting assembly according to claim 20, wherein a pulse laser whose wavelength is 1064 nm is used for the welding, and a welding torch moves at a speed of 5 mm/s to 50 mm/s.

26. The method for manufacturing a cutting assembly according to claim 20, wherein when a continuous rare-earth doped laser whose wavelength is 1070 nm±10 nm is used for the welding, a laser welding joint moves at a speed of 5 mm/s to 50 mm/s.
